(19) United States
(12) Patent Application Publication
(10) Pub. No.: US 2011/0240330 A1
(43) Pub. Date: Oct. 6, 2011

(54) SEMICONDUCTING COMPOSITION FOR ELECTRIC CABLES

(75) Inventors: Laurent Gervat, Les Clayes Sous Bois (FR); Gwenvael Le Seac'h, Saint-Avold (FR)

(73) Assignee: Arkema France, Colombes (FR)

(21) Appl. No.: 13/122,870

(22) PCT Filed: Oct. 8, 2009
(86) PCT No.: PCT/FR09/51925

§ 371 Date: Jun. 23, 2011

(30) Foreign Application Priority Data
Oct. 9, 2008 (FR) 0856851

(51) Int. Cl. H01B 9/02; C08F 220/10; H01B 1/20; H01B 1/24; B82Y 30/00

(52) U.S. Cl. 174/102 SC; 525/327.3; 526/273; 252/500; 252/511; 977/742

(57) ABSTRACT

The present invention relates to an alkyl (meth)acrylate and unsaturated epoxide crosslinked ethylene polymer. The invention also relates to a semiconducting composition including a conducting compound and an alkyl(meth)acrylate and unsaturated epoxide crosslinked ethylene polymer, to a method for making the same, and to the use thereof in electric cables.

### FIELD OF THE INVENTION

The subject matter of the present invention is a crosslinked polymer of ethylene, of alkyl acrylate or alkyl methacrylate and of an unsaturated epoxide, and also compositions comprising this polymer. The invention relates in particular to the use of this composition to manufacture electric cables.

A medium-voltage or high-voltage electric cable, that is to say a cable having an applied voltage of greater than 5000 volts, comprises at least one electrically conducting wire, often made of copper or aluminum, and a layer of insulating composition which insulates the wire from the environment. This insulating layer is generally composed of a nonpolar polymer, for example a crosslinked polyethylene. In order to be able to transport the electricity at these high voltages, these cables additionally comprise, between the conducting wire and the insulating layer, a first intermediate half-conducting half-insulating layer (commonly referred to as “inner semiconducting” layer). The main role of this layer is to capture the electrons which exit along the conducting wire and to render the electric fields homogeneous inside the cable in order to prevent premature damage to the cable. A second semiconducting layer generally covers the insulating layer. This second semiconducting layer is commonly referred to as “outer semiconducting layer”; the main role of it is to improve the efficiency of the electric cable by preventing leakage currents.

Thus, such a cable generally comprises an electrically conducting wire successively surrounded by an inner semiconducting layer, an insulating layer, an outer semiconducting layer and a protective sheath. The inner semiconducting layer must be bonded to the conducting wire and to the insulating layer, while remaining strippable. Furthermore, the outer semiconducting layer can be strippable at its interface with the insulating layer or, on the other hand, can be fully bonded to the insulating layer.

These inner and/or outer semiconducting layers can be made of a polymer composition comprising one or more crosslinked or noncrosslinked polymers.

In an electric cable, the semiconducting layers have to exhibit dielectric properties which make it possible to obtain a homogeneous electric field inside the cable and to prevent the phenomenon of dissipation of the electric energy. For this, it is necessary for the conducting compound to be fully dispersed in the composition.

### STATE OF THE ART

Semiconducting compositions are already known.

For example, the application US2008/0050588 (D1) discloses a semiconducting composition comprising a conducting compound and a multimodal ethylene homopolymer or copolymer produced by a polymerization process comprising a single-site catalyst and having a density of from 0.87 to 0.93, a melt flow index ranging from 1 to 30 and a polydispersity index of less than or equal to 10. In addition, this composition can comprise up to 10% by weight of a copolymer chosen from ethylene/butyl acrylate, ethylene/ethyl acrylate, ethylene/methyl acrylate and ethylene/vinyl acrylate copolymers.

The dielectric properties of this composition are not entirely satisfactory.

In addition, this document does not teach a good thermal stability of the semiconducting composition. In point of fact, it is necessary for this semiconducting composition to exhibit a good thermal stability in order for it not to decompose during the operation of the cable and also when said cable is manufactured. In particular, in the case where the cable comprises a layer of a polymer which has to be crosslinked, the cable is subjected to a crosslinking stage at a temperature which can be between 170 and 400° C.

Neither does anything in D1 suggest a possibility of rapid crosslinking of the polymers used. In point of fact, it is advantageous for the composition to make possible rapid manufacture of the cables in which it is present. This is because the ever-increasing growth in world energy demand requires finding solutions which make it possible to increase the productive output of electric cables. Furthermore, it is necessary for the adhesion between the inner semiconducting layer and the conductor to be excellent in order for the electric cable to have a lifetime of several years. In order to solve this problem, the document D1 recommends adding polar coupling agents. The presence of these coupling agents causes problems during manufacture, in particular of temperature behavior during the manufacture of the cables and phase separation between the polymer of the semiconducting composition and these agents. Furthermore, the cables are manufactured according to D1 by coextrusion of the various layers around the conductor. During this process, a phenomenon of shrinkback of the semiconducting layer at the two ends of the cable is generally observed, that is to say that the inner semiconducting layer retracts more than the conducting wire of the electric cable when the latter cools. The conductor is bare at its ends, which complicates the insulation of the electric cable and reduces its lifetime. The shrinkback phenomenon is reduced by increasing adhesion between the conductor and the semiconducting layer.

Furthermore, the application EP 1 065 672 (D2) reveals a semiconducting composition for an outer or inner layer based on a carbon black having specific properties and on copolymer of ethylene and of ester chosen from vinyl esters, acrylic acid esters and methacrylic acid esters. This composition does not make it possible to improve the phenomenon of shrinkback of these layers with respect to the conducting wire. Neither does this document D2 teach a better thermal stability. Finally, nothing is disclosed regarding a rapid crosslinking of the polymers of the semiconducting layer.

In addition, the document EP 1 025 161 (D3) reveals an inner semiconducting composition comprising a copolymer of ethylene and of methyl (meth)acrylate, the amount by weight of methyl (meth)acrylate of which is preferably within the range extending from 5 to 25%, with respect to the total weight of the polymer. If the inner semiconducting layer is not in perfect contact with the conducting wire and the insulating layer, holes are formed in which electric charges accumulate, which electric charges take the form of ions or electrons. These charges modify the distribution of the electric field inside the electric cable, which can result in premature breakdown of the cable. In point of fact, the composition of D3 does not make it possible to improve this phenomenon. It is also necessary for the semiconducting layer to have a particularly smooth surface condition and a uniform thickness, very particularly for the inner layer. This is because, in the reverse case, what are commonly referred to as “point effects” are created, which can also result in breakdown of the electric cable. Here again, the composition of D3 does not make it possible to improve this phenomenon. Neither does this document D3 disclose an improvement in the dielectric properties of the composition. Furthermore, even if the composition has a slightly improved thermal stability, it does not make it possible to significantly increase the rate of crosslinking of the polymers constituting it, in comparison with compositions comprising different copolymers of ethylene and of alkyl (meth)acrylate.

The patent U.S. Pat. No. 6,248,374 (D4) discloses a strippable outer semiconducting layer, this layer comprising either a copolymer of ethylene and of vinyl acetate, the weight-average molecular weight of which is greater than 30000 or the melting point of which ranges from 60 to 80° C., or a blend of ethylene/vinyl acetate copolymer and of a polyolefin having a melting point of 120° C. or more. This layer is used only as outer layer and cannot be used as inner layer. The thermal stability of this layer is very poor. Furthermore, its dielectrical properties are not entirely satisfactory and the point effect phenomenon is not improved.

Polymers based on ethylene, on alkyl (meth)acrylate and on unsaturated epoxide are described in the document EP 0 802 226 (D5) for the manufacture of injection-molded polyamide parts with improved impact properties by virtue of this polymer, the epoxide functional group being grafted or copolymerized with the ethylene. This document does not relate to semiconducting compositions or to electric cables; furthermore, the latter are never formed by injection molding but by coextrusion.

The document WO 2005/030870 A1 (D6) discloses a composition comprising at least 40% of polyester, from 3 to 30% of a polymeric reinforcement comprising reactive functional groups, a reinforcing agent of a specific size and an electrically conducting compound. The polymeric reinforcement is not crosslinked. The composition exhibits the advantage of being able to be painted. It has a resistivity very different from that of the semiconducting compositions used in the cables.

A subject matter of the document WO 96/28510 A1 (D7) is a composition comprising mainly a polyacetal resin, an olefinic polymer comprising a glycidyl group, polydimethylsiloxane and, in addition, from 0.05 to 5% of carbon black, with respect to the total weight of the composition. The olefinic polymer is not crosslinked. The aim of the invention is to improve the resistance to heat of the polyacetal resin and also its resistance to fats and to friction. This document does not relate either to electric cables.

There thus exists today a need for novel “semiconducting” compositions which make it possible to improve at least one of the abovementioned properties and to thus facilitate the manufacture of electric cables.

A subject matter of the present invention is precisely a semiconducting layer composition which adheres to numerous supports while remaining strippable. It is of particular use as inner and/or outer layer in an electric cable which makes it possible to overcome the above disadvantages.

### SUMMARY OF THE INVENTION

More specifically, the invention relates to a novel polymer which makes possible the manufacture of strippable semiconducting compositions which have highly advantageous properties and which make it possible to facilitate the manufacture of electric cables.

The polymer according to the invention is a polymer of ethylene, of unsaturated epoxide and optionally of alkyl acrylate or alkyl methacrylate, these esters being combined under the term alkyl (meth)acrylate hereinafter in the description; this copolymer comprises, with respect to its total weight:
from 48 to 99.9% by weight of ethylene and in particular from 48 to 94.9%;
from 0 to 40% by weight of alkyl (meth)acrylate and in particular from 5 to 40%;
from 0.1 to 12% by weight of unsaturated epoxide.

The polymer according to the invention is crosslinked via a C-C bond.

The applicant company has discovered that the polymer according to the invention makes possible the manufacture of semiconducting compositions exhibiting an improvement, with respect to the compositions of the prior art, in at least one property described above, that is to say an improvement in the dielectric properties and/or in the thermal resistance and/or in the rate of crosslinking of the polymers and/or in the adhesion of this composition to a conducting wire and/or the surface condition of a layer of this composition.

The compositions according to the invention comprising the above polymer make it possible to manufacture electric cables having excellent properties, without having to modify the manufacturing processes conventionally used.

The summary of the document JP 06116362 (D8) describes a composition comprising an olefinic polymer carrying epoxy groups, an agent which crosslinks epoxy groups and an electrically conducting carbon black. The epoxy functional groups thus react with the crosslinking agent, this agent then participating in the structure of the crosslinked polymer; the epoxy functional group reacts with the agent and the polymer is crosslinked via a C—O—C bond. The polymer according to the invention is thus different in that it is crosslinked via a C—C bond, in that the epoxy functional groups do not react with the crosslinking agent and in that the structure of the polymer does not comprise the crosslinking agent. One problem of this composition is that it adheres strongly to the metal conducting wire, which makes it difficult to use it as inner semiconducting layer. Furthermore, the stripping of the outer semiconducting layer from the insulating layer remains difficult.

In the polymer according to the invention, the epoxy functional groups are thus available. Without being committed to any one theory, the applicant company assumes that the presence of these epoxy functional groups on the ethylene-comprising crosslinked polymer allows the polymer to adhere to a nonpolar support, such as a crosslinked polyethylene, while being more easily strippable in comparison with a crosslinked polymer, the epoxy functional groups of which have reacted with a crosslinking agent. Likewise, the presence of these epoxy functional groups in the ethylene-comprising crosslinked polymer also makes it possible to reduce the phenomenon of shrinkback when it is brought into contact in the molten state with a metal. Although the polymer adheres to the metal, it can be separated by stripping when a simple stress is applied, in contrast to the polymer where the functional groups have reacted with the crosslinking agent.

These properties are of particular use in the manufacture of electric cables, in particular for manufacturing inner or outer semiconducting layers.

Preferably, the crosslinked polymer has a structure which does not comprise the crosslinking agent.

An advantageous way of determining if the crosslinking is carried out via a C—C bond is to measure the amount of units resulting from monomers carrying epoxide functional groups included in the crosslinked polymer. This amount is greater than or equal to 98% of that included in the noncrosslinked polymer, preferably greater than or equal to 99%, very preferably from 99.5 to 100%.

According to the invention, the word “polymer” means a copolymer of ethylene, of unsaturated epoxide and optionally of alkyl acrylate or methacrylate resulting from the polymerization of ethylene with at least one unsaturated epoxide and optionally at least one alkyl acrylate or methacrylate, in combination with optionally one or more other comonomers which can polymerize by the radical route.

Advantageously, the polymer according to the invention comprises, with respect to its total weight:
from 66 to 77.1% by weight of ethylene;
from 22.5 to 30% by weight of alkyl (meth)acrylate;
from 0.4 to 4% by weight of unsaturated epoxide.

The invention also relates to the use of the polymer to manufacture electric cables.

A subject matter of the invention is more particularly a semiconducting composition which comprises, in addition to the polymer, a conducting agent in amounts sufficient to produce the semiconducting effect.

The composition according to the invention exhibits, surprisingly, all the characteristics necessary to be able to be advantageously used as semiconducting composition and in particular in electric cables.

Another subject matter of the invention is a process for the manufacture of the crosslinked polymer, comprising a stage of blending the noncrosslinked polymer with an organic peroxide and a stage of crosslinking the polymer by heating the polymer.

Another subject matter of the invention is a process for the manufacture of the semiconducting composition, comprising a stage of blending the various constituents, and also an electric cable comprising this composition.

The invention will now be described in detail in the part which follows.

### DETAILED DESCRIPTION OF THE INVENTION

The polymer according to the invention is a polymer, crosslinked via a C—C bond, of ethylene, of unsaturated epoxide and of alkyl acrylate or alkyl methacrylate, these esters being combined under the term alkyl (meth)acrylate hereinafter in the description; this polymer comprises, with respect to its total weight:
from 48 to 99.9% by weight of ethylene and in particular from 48 to 94.9%;
from 0 to 40% by weight of alkyl (meth)acrylate and in particular from 5 to 40%;
from 0.1 to 12% by weight of unsaturated epoxide.

Advantageously, the polymer comprises, with respect to its total weight,
from 62 to 77.9% by weight of ethylene;
from 22 to 32% by weight of alkyl (meth)acrylate;
from 0.1 to 6% by weight of unsaturated epoxide.

Advantageously, the polymer according to the invention comprises, with respect to its total weight:
from 66 to 77.1% by weight of ethylene;
from 22.5 to 30% by weight of alkyl (meth)acrylate;
from 0.4 to 4% by weight o f unsaturated epoxide.

According to a first embodiment, the polymer according to the invention comprises, with respect to its total weight:
from 69.5 to 76.5% by weight of ethylene;
from 23 to 28% by weight of alkyl (meth)acrylate;
from 0.5 to 2.5% by weight of unsaturated epoxide.

Advantageously, the amount of ethylene is less than 75% by weight, with respect to the total weight of the polymer.

According to another embodiment, the polymer of the invention can also comprise, preferably, with respect to its total weight:
between 69.5 and 75% by weight of ethylene;
from 22.5 to 30% by weight of alkyl (meth)acrylate;
from 2.5 to 0.5% by weight of unsaturated epoxide.

As regards the alkyl (meth)acrylate of the terpolymer according to the invention, the alkyl chain can have up to 24 carbon atoms. Preference is given to those in which the alkyl chain comprises from 1 to 12 carbon atoms, advantageously from 1 to 6, indeed even from 1 to 4. Advantageously, the alkyl (meth)acrylates are n-butyl acrylate, isobutyl acrylate, 2-ethylhexyl acrylate, ethyl acrylate and methyl acrylate. Preferably, the alkyl (meth)acrylates are n-butyl acrylate, ethyl acrylate and methyl acrylate. Very preferably, the alkyl (meth)acrylate is methyl acrylate.

Surprisingly, a better dispersion of the conducting compound is obtained with (meth)acrylates of this type than in the case where the polymer does not comprise them.

The amount of alkyl (meth)acrylates in the polymer is, for example, within the range extending from 22 to 32%, with respect to the total weight of the polymer, advantageously from 22.5 to 30%, preferably from 23 to 28%.

Mention may be made, as example of unsaturated epoxides, of aliphatic glycidyl esters and ethers, such as allyl glycidyl ether, vinyl glycidyl ether, glycidyl maleate and itaconate, or glycidyl (meth)acrylate, and of alicyclic glycidyl esters and ethers, such as 2-cyclohexen-1-yl glycidyl ether, diglycidyl cyclohexene-4,5-dicarboxylate, glycidyl cyclohexene-4-carboxylate, glycidyl 5-norbornene-2-methyl-2-carboxylate and diglycidyl endo-cis-bicyclo[2.2.1]hept-5-ene-2,3-dicarboxylate. Preference is given, as unsaturated epoxide, to glycidyl methacrylate, due to its high polarity, which promotes in particular its properties of dispersion and of crosslinking in the composition according to the invention.

The amount of epoxide in the polymer is, for example, within the range extending from 0.1 to 6% by weight, with respect to the total weight of the polymer, advantageously from 0.4 to 4% and preferably from 0.5 to 2.5%.

The amounts of the various monomers present in the polymer can be measured by infrared spectroscopy using the standard ISO8985.

The melt flow index of the noncrosslinked polymer is advantageously from 1 to 500 g/10 min, measured according to the standard ASTM D 1238 at 190° C. and at 2.16 kg, preferably from 20 to 70 g/10 min and very preferably between 30 and 55 g/10 min.

The process of extrusion of an electric cable is particularly improved within these fluidity ranges; in particular, they surprisingly make possible a rapid extrusion of the electric cable. Furthermore, the semiconducting layer has a particularly smooth surface condition which is particularly appropriate for the use thereof as an inner layer. During the crosslinking of the polymer, the semiconducting layer has an excellent dimensional and thermal stability.

Preferably, the Vicat softening temperature of the polymer of the invention, measured according to the standard ASTM D 1525, is less than 90° C.

The noncrosslinked polymer of ethylene, of alkyl (meth)acrylate and of unsaturated epoxide can be obtained by radical copolymerization of ethylene, of the alkyl (meth)acrylate and of an unsaturated epoxide. Use may be made of the “radical polymerization” processes normally operating at pressures of between 200 and 2 500 bar. These polymerization processes, known to a person skilled in the art, are carried out industrially using two main types of reactors: a reactor of autoclave type or a reactor of tubular type. Advantageously, the polymer according to the invention is manufactured in an autoclave reactor. These high-pressure polymerization processes in an autoclave reactor are well known to a person skilled in the art and are, for example, described in patent applications FR 2 498 609, FR 2 569 411 and FR 2 569 412; the polymer is obtained according to these processes by replacing maleic anhydride with the unsaturated epoxide.

On using this type of process, it is found that, in the manufacture of a layer of semiconducting composition, an improved surface condition and a better dispersion of the conducting compound in the composition are obtained, in comparison with a polymer manufactured in a tubular reactor. This results in an electric cable exhibiting improved properties.

The polymer according to the invention is crosslinked via a C—C bond. The crosslinking agent may not participate in the crosslinked polymer. The crosslinked polymer according to the invention is capable of being obtained, for example, via an organic peroxide (for example those of the Luperox® range which are sold by the applicant company). The term “organic peroxide” is understood to mean any hydrocarbon molecule comprising a functional group of O—O peroxy type. Mention may be made, for example, of dicumyl peroxide, tert-butyl cumyl peroxide, 2,5-dimethyl-2,5-di(t-butylperoxy)hexane, bis(t-butylperoxy)diisopropylbenzene and 2,5-dimethyl-2,5-di(t-butylperoxy)hex-3-yne. The crosslinking agents are generally present in amounts included within the range extending from 0.2 to 4% by weight, with respect to the total weight of the composition, preferably from 0.4 to 2%.

The crosslinking of the polymer is generally quantified by the measurement of the gel content. This gel content can be measured using method A of the standard ASTM D 2765-01 (2006). Advantageously, the gel content of the polymer is greater than or equal to 10, preferably greater than or equal to 20, for example greater than or equal to 50.

The invention also relates to a process for the manufacture of the crosslinked polymer comprising a stage of blending the noncrosslinked polymer with an organic peroxide and a stage of crosslinking the polymer by heating the polymer.

Preferably, the stage of blending the peroxide with the noncrosslinked polymer is carried out at a temperature below the decomposition temperature of the peroxide, for example at a temperature ranging from 80° C. to 150° C., for example from 90 to 120° C. This blend can be prepared by the normal techniques of blending thermoplastic compositions, such as, for example, single-screw extrusion, twin-screw extrusion or with any type of mixer, such as internal mixers, external mixers or mixers of Buss type.

The stage of crosslinking the polymer is preferably carried out at a temperature greater than or equal to the decomposition temperature of the peroxide, for example at a temperature between 170 and 400° C., advantageously between 200 and 380° C. It is possible, subsequent to the blending stage, to form the polymer and optionally to combine it with other materials in a multilayer structure in order to give it the desired final form. The invention also relates to an object comprising the polymer according to the invention.

The polymer can also be crosslinked when it is blended with other components in a composition, in particular when it is blended in the composition according to the invention which is described hereinafter.

Another subject-matter of the invention is a semiconducting composition. The latter comprises, in addition to the crosslinked polymer, a conducting compound which is generally carbon black. Use may be made, in the invention, of any type of conducting carbon black, such as, for example, acetylene black or furnace black. Preferably, the composition is regarded as exhibiting a semiconducting effect when it exhibits a volume resistivity of less than 1000 ohm.em, measured according to the standard ISO 3915 at 23° C., preferably of less than 500 ohm.cm. Use is generally made, in order to obtain this resistivity, of an amount of carbon black of 20 to 50% by weight, with respect to the total weight of the composition, preferably of 25 to 45%. The conducting compound can also be carbon nanotubes or a mixture of carbon nanotubes with carbon black.

The amount of polymer in the semiconducting composition according to the invention can be from 1 to 90% by weight, with respect to the total weight of the composition, preferably from 50 to 80%, indeed even from 55 to 75%.

It would not be departing from the invention for the polymer according to the invention to be replaced by a blend of polymer according to the invention and of a polyolefin different from the polymer according to the invention, referred to as “diluting polyolefin”.

Mention may be made, as diluting polyolefin which can be used in the invention, of ethylene homopolymers and copolymers. The ethylene copolymers can be copolymers of ethylene and of olefins comprising from 3 to 20 carbon atoms. Mention may be made of high-density polyethylene, medium-density polyethylene, low-density polyethylene, linear low-density polyethylene, very low density polyethylene, polyethylene obtained by metallocene catalysis or also ethylene and propylene rubbers of EPR or EPDM type. Mention may also be made of copolymers of ethylene and of alkyl (meth)acrylate (the alkyl chain of which preferably comprises from 1 to 12 carbon atoms, preferably from 1 to 4) or copolymers of ethylene and of vinyl ester, such as, for example, copolymers of ethylene and of vinyl acetate.

Mention may be made, as diluting polyolefin other than ethylene homopolymers and copolymers, for example, of propylene or isoprene homopolymers and copolymers.

Advantageously, the diluting polyolefin is an ethylene homopolymer or copolymer, very preferably an ethylene/alkyl (meth)acrylate copolymer.

In the case where the polymer is blended with a diluting polyolefin, the diluting polyolefin/polymer ratio is advantageously included within the range extending from 0.1 to 10, preferably from 0.2 to 0.8.

Advantageously, the level of epoxide by weight with respect to the total weight of the blend (polymer+diluting polyolefin is included within the range extending from 0.5 to 3%, preferably from 1.5 to 2%.

The polyolefins of the invention optionally participating in the composition according to the invention are also crosslinked.

The composition can also comprise the additives normally used in semiconducting compositions for electric cables.

Mention may be made, among the additives normally used in semiconducting compositions, of fillers, processing aids and lubricants, stabilizers, antioxidants and ozone protectants, additives which prevent water tree or vented tree phenomena, antitack agents or hydrolysis protectants.

Mention may be made, among fillers, of talc, calcium carbonate or clays.

Microcrystalline waxes, paraffins or polyethylene glycol can be used as processing aids and lubricants.

Phenolic compounds may be mentioned as antioxidants and ozone protectants.

An example of antitack agent is ethylenebisstearamide.

Agents based on polycarbodiimide can be used as hydrolysis protectants.

According to one form of the invention, the composition also comprises a “polymer additive” polymer chosen from acrylonitrile/butadiene copolymers, amide waxes, silicon oils, chlorosulfonated polyethylene or polychloroprene. With this polymer additive, the composition thus obtained is even more easily strippable on a polyethylene; it can advantageously be used as outer layer. In the case where the composition does not comprise this type of polymer additive, the thermal stability of the composition is better. Preferably, the polymer additive is an acrylonitrile/butadiene copolymer. Another subject matter of the invention is an electric cable comprising a layer of the composition according to the invention.

The electric cables are generally manufactured in two stages. A “precable”, composed of the conducting wire, the inner semiconducting layer, the insulating layer and the outer semiconducting layer, is extruded and then wound around a cable drum. The external temperature of the precable is generally approximately 70° C. during the winding. At this temperature, the precable can stick slightly to itself. It is then necessary either to add antitack agents, which can damage the properties of the semiconducting layer, or to slow down the rate of manufacture of the cable in order to allow it to cool.

A surprising advantage of the composition according to the invention used as outer layer is that it is less tacky at this temperature in comparison with the outer compositions based on ethylene/vinyl acetate or ethylene/butyl acrylate copolymer conventionally used. Without being committed to any one theory, the applicant company explains this phenomenon by a higher Vicat crystallization or softening temperature of the terpolymer of the composition than that of the ethylene/vinyl acetate or ethylene/butyl acrylate copolymers having an identical polarity.

Preferably, the total amount of additives apart from polymer additive with respect to the total weight of the composition is included within the range extending from 0.01 to 10%.

According to a specific embodiment of the invention, the semiconducting composition comprises:
the polymer according to the invention or a blend of diluting polyolefin and a polymer;
the conducting compound in an amount sufficient to produce a semiconducting effect;
optionally at least one of the additives normally used in semiconducting compositions.

This semiconducting composition can be used equally well as inner layer as outer layer, which constitutes an advantage.

Preferably, according to this embodiment, the composition comprises, with respect to its total weight:
from 50 to 80% of polymer according to the invention or of blend of diluting polyolefin and of polymer, preferably from 55 to 75%;
from 20 to 50% of carbon black, preferably from 25 to 45%;
optionally at least one of the additives normally used in semiconducting compositions;
the sum of the constituents coming to 100%.

The compositions of this embodiment can comprise the additive or additives in the amounts described above.

Another subject matter of the invention is a process for the manufacture of the semiconducting composition, comprising a stage of blending the various constituents.

The compositions of the invention can be prepared by the usual techniques for blending thermoplastic compositions, such as, for example, single-screw extrusion, twin-screw extrusion or with mixers of any type, such as internal mixers, external mixers or mixers of Buss type. Preferably, the temperature of the blending is included within the range extending from 80 to 170° C., for example from 80 to 150° C.

As described above, the polymer according to the invention can be crosslinked when it is blended with other components in a composition. Thus, the invention also relates to a process for the manufacture of the composition, comprising a stage of blending the various constituents, that is to say the noncrosslinked polymer, the conducting compound, the organic peroxide, optionally a diluting polyolefin and optionally the abovementioned additives. The manufacturing process comprises a stage of crosslinking the composition. Preferably, the blending stage is carried out at a temperature below the decomposition temperature of the peroxide, for example a temperature ranging from 80 to 150° C. or from 90 to 120° C. This blend can be prepared by the usual techniques for blending thermoplastic compositions, such as, for example, single-screw extrusion, twin-screw extrusion or with mixers of any type, such as internal mixers, external mixers or mixers of Buss type. The stage of crosslinking the composition is preferably carried out at a temperature greater than or equal to the decomposition temperature of the peroxide, for example at a temperature between 170 and 400° C., advantageously between 200 and 380° C. It is possible, subsequent to the blending stage, to form the polymer and optionally to combine it with other materials in a multilayer structure in order to give it the desired final form. This forming can optionally be carried out simultaneously with the blending stage, for example by extrusion of electric cable, or a layer of the polymer to be crosslinked is included in the cable.

Another subject matter of the invention is the use of the composition as semiconducting layer in electric cables. It relates in particular to the use of this composition as inner layer and/or outer layer. The invention also relates to an electric cable comprising, as inner and/or outer layer, a semiconducting composition according to the invention.

Another subject matter of the invention is a process for cable manufacture.

The cable can be formed by coextrusion of the various constituent layers, comprising the conducting wire, the inner semiconducting layer, the insulating layer and the outer semiconducting layer, said inner and/or outer semiconducting layer being according to the invention.

The process for the manufacture of the cable can advantageously comprise a crosslinking stage. This heat treatment is conventionally carried out within a range of between 170 and 400° C., advantageously between 200 and 380° C.

### EXAMPLES

The semiconducting compositions were manufactured from the following products:
Terpolymer comprising, by weight, 74% of ethylene, 24% of methyl acrylate and 2% of glycidyl methacrylate, having a melt flow index of 50 g/10 min, measured according to the standard ASTM D 1238 at 190° C. and at 2.16 kg;
Conducting compound: furnace black;
Antioxidant: pentaerythritol tetrakis(3-(3,5-di(tert-butyl)-4-hydroxyphenyl)propionate);
Crosslinking agent: dicumyl peroxide.

### Example 1

The composition of example 1 comprises, with respect to its total weight:
63.5% of terpolymer;
35% of carbon black;
0.5% of antioxidant;
1% of crosslinking agent.

### Example 2

The composition of example 2 comprises, with respect to its total weight:
51.5% of terpolymer;
12% of butadiene/acrylonitrile copolymer;
35% of carbon black;
0.5% of antioxidant;
1% of crosslinking agent.

The compositions according to examples 1 and 2 comprise terpolymers crosslinked via a C—C bond.

### Example CP (Comparative)

The composition of this example is identical to that of example 1, except for the fact that the crosslinking agent is not a peroxide but 1% of maleic acid.

The composition according to example CP comprises a terpolymer crosslinked via the epoxy functional group and thus via a C—O—C bond.

The compositions of example 1 (according to the invention) and of example CP were used in a cable as inner semiconducting layer. The composition of example 1, 2 (according to the invention) and of example CP were used as outer semiconducting layer.

The cable exhibits the following structure:

Conducting wire/(inner semiconducting) composition/crosslinked polyethylene/(outer semiconducting) composition.

The compositions according to the invention exhibit the expected advantages when they are used according to conventional processes for the manufacture of an electric cable.

In the case of example 1, the composition adheres to the conducting wire but remains strippable on pulling the layer of the composition. The composition also adheres to the polyethylene while remaining strippable. In comparison, the composition of example CP exhibits good adhesion to the conducting wire but is not strippable. The compositions according to examples 1 and 2 are also more easily strippable on the crosslinked polyethylene than in the case of example CP.

1. A crosslinked polymer of ethylene, optionally of alkyl (meth)acrylate and of unsaturated epoxide comprising, with respect to the total weight of the terpolymer:
from 48 to 99.9% by weight of ethylene units;
from 0 to 40% by weight of alkyl (meth)acrylate units;
from 0.1 to 12% by weight of unsaturated epoxide units;
wherein it is crosslinked via a C-C covalent bond.

2. The polymer as claimed in claim 1, wherein said polymer does not comprise a crosslinking agent.

3. The polymer as claimed in claim 1, wherein the amount of units resulting from the unsaturated epoxide is greater than or equal to 98% of that of the polymer before crosslinking.

4. The polymer as claimed in claim 1, obtained by a process of crosslinking via an organic peroxide.

5. The polymer as claimed in claim 1, wherein it comprises, with respect to the total weight of the polymer:
from 66 to 77.1% by weight of ethylene units;
from 22.5 to 30% by weight of alkyl (meth)acrylate units;
from 0.4 to 4% by weight of unsaturated epoxide units.

6. The polymer as claimed in claim 1, wherein the alkyl chain of the (meth)acrylate comprises from 1 to 12 carbon atoms.

7. The polymer as claimed in claim 1, wherein the alkyl (meth)acrylate is chosen from methyl acrylate, ethyl acrylate and n-butyl acrylate.

8. The polymer as claimed in claim 1, wherein the unsaturated epoxide is glycidyl methacrylate.

9. A composition, comprising a conducting compound and a polymer as claimed in claim 1.

10. The composition as claimed in claim 9, additionally comprising a crosslinked diluting polyolefin different from the polymer.

11. The composition as claimed in claim 9, additionally comprising at least one additive different from the polymer and from the conducting compound.

12. The composition as claimed in claim 9, comprising, with respect to its total weight:
from 50 to 80% of polymer or of a blend of diluting polyolefin and of polymer;
from 20 to 50% of carbon black and/or carbon nanotubes;
optionally at least one additive different from the polymer and from the conducting compound;
the sum of the components coming to 100%.

13. A process for the manufacture of a composition as claimed in claim 9, comprises a stage of blending the various constituents of said composition.

14. (canceled)

15. An electric cable, comprising a layer of said composition as claimed in claim 9 as a semi-conducting layer.
